(19) United States
(12) Patent Application Publication
(10) Pub. No.: US 2012/0158446 A1
(43) Pub. Date: Jun. 21, 2012

(54) Determining Impacts Of Business Activities

(76) Inventors: Jochen Mayerle, Flein (DE); Clemens Jacob, Mannheim (DE); Christoph Ehrhardt, Mannheim (DE)

(21) Appl. No.: 12/973,816

(22) Filed: Dec. 20, 2010

(51) Int. Cl. G06Q 10/00

(52) U.S. Cl. 705/7.11

(57) ABSTRACT

A first entity responsible for a first stage in a life-cycle of at least one of a product can receive a service, an entity, a process, and a business unit, a data container from a second entity responsible for a second stage in the life-cycle. The second stage can precede the first stage in the life-cycle. The data container can include second impact data quantifying impacts of each second activity of the second entity relating to the life-cycle and third impact data quantifying impacts of each third activity of a third entity relating to the life-cycle. The third entity can be responsible for a third stage in the life-cycle that either precedes or follows the first stage. First impact data quantifying impacts of each first activity of the first entity relating to the life-cycle can be calculated and added to the data container. An aggregate impact of all or part of the life-cycle can be calculated by applying an impact calculation algorithm whose inputs comprise the first impact data, the second impact data, and the third impact data. The data container can be passed to the second entity and the third entity, and the aggregate impact can be promoted. Related systems, methods, and articles of manufacture are described.

### TECHNICAL FIELD

The subject matter described herein relates generally to data processing and, in particular, to monitoring business activities and determining an impact and/or a resulting value of such business activities.

### BACKGROUND

Every product, service, activity, or the like produced by an organization (e.g. a business, government or government agency, educational institution, or the like) has a particular life-cycle, which can include multiple stages, each of which is capable of producing an environmental impact. The stages may include obtaining raw materials that may be used to product and/or develop a particular product and/or service, manufacture of the product and/or creation of a particular service, distribution and/or providing product/service to the consumer, usage of the product/service by the consumer, and eventually disposal and/or termination of the product/service. Assessment of the environmental impact produced by each stage of the life-cycle of the product/service can be important for determination of various factors such as costs involved in development, manufacture, distribution and disposal of the product/service, allocation of available resources, impact on future environmental conditions, compliance with regulatory provisions, as well as many other factors that can be vital to operation of a successful business enterprise.

### SUMMARY

In one aspect, a computer-implemented method includes receiving, at a first entity responsible for a first stage in a life-cycle of at least one of a product, a service, an entity, a process, and a business unit, a data container from a second entity responsible for a second stage in the life-cycle. The second stage precedes the first stage in the life-cycle. The data container includes second impact data quantifying impacts of each second activity of the second entity relating to the life-cycle and third impact data quantifying impacts of each third activity of a third entity relating to the life-cycle. The third entity is responsible for a third stage in the life-cycle that either precedes or follows the first stage. First impact data quantifying impacts of each first activity of the first entity relating to the life-cycle are calculated and added to the data container. An aggregate impact of all or part of the life-cycle is calculated by applying an impact calculation algorithm whose inputs comprise the first impact data, the second impact data, and the third impact data. The data container is passed to the second entity and the third entity, and the aggregate impact is promoted.

In some variations one or more of the following can optionally be included. The aggregate impact can include at least one of an environmental impact, a financial impact, a legal impact, a political impact, a regulatory impact, a business impact, and a social impact. The first impact data, the second impact data, and the third impact data each can include information concerning at least one external factor associated with the life-cycle of the product. The container can include the impact data values as at least one of totals and vectors. The promoting can include generating a report comprising at least one of quantified impacts associated with each of the first activity, second activity, and third activity; total impacts associated with each of the first entity, the second entity, and the third entity; the aggregated impact; and cost information associated with each quantified impact. The promoting can also include at least one of storing the report on a computer storage device, displaying the report to a user via a computer display device, and electronically transmitting the report to one or more users. The calculating of the aggregate impact can further include representing each of the first entity, the second entity, and the third entity nodes or edges in a net-like computation structure. The impact calculation algorithm can include an operator that performs computations on at least one of the nodes and the edges in the net-like structure. The operator can be editable independently of a definition of the net-like computation structure. A new container can be derived dynamically at runtime to support a newly specified calculation whose definition can be received via input from a user.

Articles are also described that comprise a tangibly embodied machine-readable medium operable to cause one or more machines (e.g., computers, etc.) to result in operations described herein. Similarly, computer systems are also described that may include a processor and a memory coupled to the processor. The memory may include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A and FIG. 1B show diagrams illustrating life-cycles of two examples of products and interdependencies between stages in the life-cycles;

FIG. 2 shows a product life-cycle component diagram;

FIG. 3 shows a diagram illustrating impacts along the life-cycle of a product;

FIG. 4 shows an example of a determination of a carbon dioxide emission impact over part of a life-cycle of a product;

FIG. 5 shows a flowchart illustrating a method; and

FIG. 6 shows a diagram of a system consistent with implementations of the current subject matter.

When practical, similar reference numbers denote similar structures, features, or elements.

### DETAILED DESCRIPTION

There is a need for monitoring, assessing, and determining an environmental impact of a life-cycle of a product or service from a “birth” of a product, service, and/or units or sub-entities of the same (e.g., obtaining materials needed to create the product or service) to eventual “grave” of the product, service, and/or units or sub-entities (e.g., disposal of the product or termination of the service). Implementations of the current subject matter provide methods, systems, articles or manufacture, and the like that can, among other possible advantages, provide automated and dynamic assessment of impacts of a life-cycle of a product or a service. For ease of explanation of the current subject matter, throughout this disclosure and in the claims, the term “product” will be used to refer interchangeably to either a product or a service whose provision involves activities of at least a first entity and a second entity.

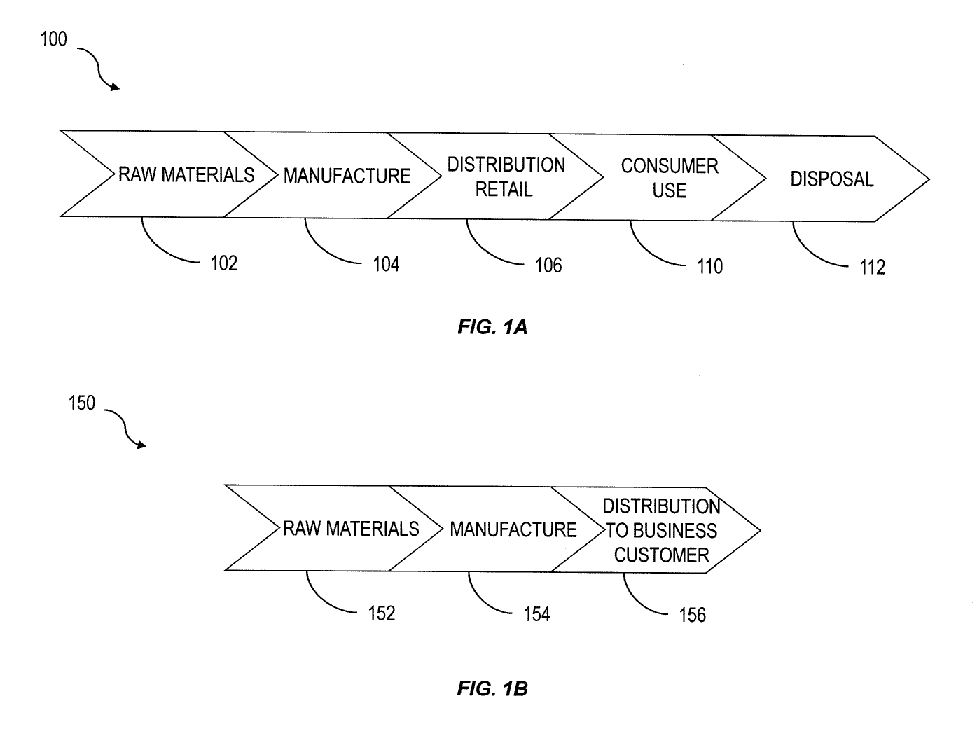

FIG. 1A and FIG. 1B illustrate two possible life-cycles of a product or a service. Referring to FIG. 1A, a business-to-consumer scenario 100 for a life-cycle of a product or service is illustrated. In some implementations, the life-cycle of a product can begin with obtaining of raw materials 102. Some examples of such obtaining can include coal and metal mining, oil exploration and drilling, seawater desalination, and other types of processes. Once the raw materials have been obtained, the life-cycle can proceed to manufacturing of the product 104. Manufacturing can involve production of plastics, resin, and/or food from oil, production of jewelry from gold, silver, etc., and/or any other processes. Upon completion of the manufacturing, the life-cycle of the product can move to distribution and retail 106 of the product. During this stage, the product can be distributed to the various sellers and resellers of products (or suppliers of service), such as warehouses, dealers, shopping malls, shops and various other vendors. Consumers of the product can purchase the product from a retailer of their choice, thereby advancing the life-cycle of the product to consumer use stage 110. Consumers can use the purchased (or otherwise received) product according to their needs (whether or not in accordance with the manufacturer/retailer guidelines). For example, if the product is a vehicle purchased from a car dealer, the consumer can drive the car for pleasure and/or to work, which generates an environmental impact. Once the consumer no longer has any need for the product, the consumer can dispose of it. Disposal 112 can include taking the product that is no longer being used (or is not operational) to a disposal facility, recycling facility, or any other entity that can accept products that the consumer has no desire to use anymore. Once the product is disposed 112, its life-cycle ends.

FIG. 1b illustrates an exemplary life-cycle of a product or a service in a business-to-business scenario 150 consistent with implementations of the current subject matter. Similarly to FIG. 1A, the life-cycle of a product can begin with obtaining of raw materials 152 that may be needed to manufacture the product. Once the raw materials are obtained, the product can be manufactured, as shown at 154. Upon completion of manufacture, the product can be distributed 156 to business customers. At this point, the life-cycle of the product can terminate as it concerns the various entities that are involved in the scenario 150. Alternatively, the product can be distributed to the customers, as illustrated in FIG. 1A, then used by the individual customers, and eventually disposed of. The current subject matter is not limited to the exemplary life-cycle scenarios illustrated in FIG. 1A and FIG. 1B.

Each stage in the life-cycle of a product can produce a footprint or an impact on the surrounding environment. Such impact can include water usage, carbon dioxide exhaust, electricity usage, exhaust and/or production of hazardous materials as byproducts of various stages of life-cycle of the product, air pollution, as well as many other impacts. The produced impact is not limited to an environmental impact, but can also include financial impact (e.g., increasing inflation, etc.), social impact, political impact (e.g., changing governments, enacting new laws, etc.), and other impacts. For ease of description and illustration, the following discussion will be presented in terms of an environmental impact.

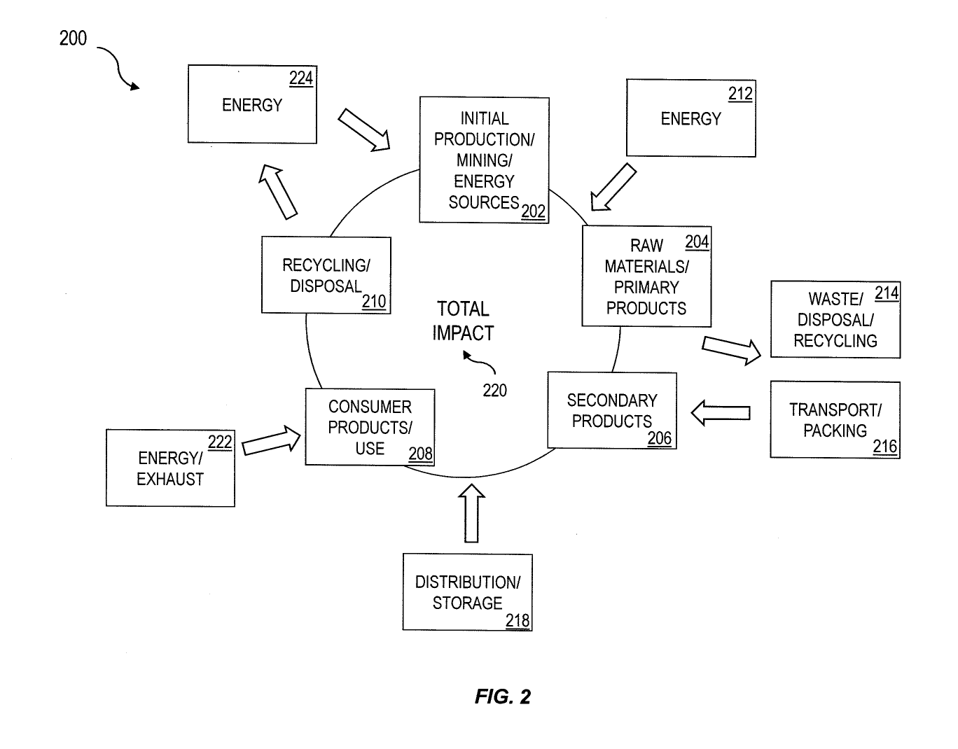

FIG. 2 shows a life-cycle diagram 200 illustrating impacts that can be produced during the life-cycle of a product. Production of a particular product can include multiple discrete impacts, for example obtaining of initial production, mining, energy sources and the like; obtaining raw materials or producing primary products 204; production of secondary products 206; production or use of consumer products 208; recycling or disposal 210; and the like that can involve multiple entities.

It may be necessary to obtain raw materials by way of mining, exploration, or otherwise development of various natural resources (e.g., oil, gas, coal, metals, water, etc.), as shown at 202. Various entities can be involved in obtaining such raw materials, including mining companies, oil exploration and drilling companies, metal mining companies, water processing plants, and/or many others. Such obtaining of raw materials can produce an impact on the environment as various entities involved in mining, exploration, and/or development, etc. use various forms of energy for various processes that can be implemented by these entities. Each such entity can produce a different scope and level of an environmental impact depending on the types of processes the entity uses; the entity's forms of complying with business, financial, regulatory, legal, and environmental standards and regulations; the entity's internal business standards, the state of the environment at the location(s) where the entity performs its activities, and many other factors.

Production of raw materials or primary products 204 can be produced using energy input 212, for example by one or more entities performing the initial obtaining of the materials 202 or by other entities. In the event that other entities are involved in obtaining the raw materials, additional impacts on the environment can be incurred through transportation, storage, and any processing performed by these entities. The raw materials or primary products 204 can be used to produce secondary products 206 (e.g., a raw product of crude oil can be used to produce a secondary product—resin, plastics, food, and the like). During production of the secondary products 206, the entities involved in such production can produce waste and dispose and/or recycle such waste 214. Various forms of energy can be used to produce such secondary products 206 that can involve electricity, water, air, other primary and/or secondary products, etc. Additionally, it may be necessary to transport and/or pack raw or primary materials 204 for the purposes of delivering them to the entities that can be involved in the production of the secondary materials 206. Such transport/packing 216 can involve production of various forms of environmental impact from production of carbon dioxide to water waste.

Production of the secondary products 206 can also involve various forms of an environmental impact. Production of secondary products 206 from primary products 204 can involve some form of conversion, processing, pre- and post-processing, as well as any other operations that may need to be performed in order to make the secondary products. Such production can use various resources, such as energy, electricity, water, gas, oil, etc., and produce exhaust, waste, recyclable materials, hazardous materials, etc., each of which can produce a varying degree environmental impact.

Once the secondary products are made, they can be distributed to consumers for their eventual use 208. In the alternative, the products can be stored. Distribution and/or storage 218 can also impact the environment in various ways. For example, storage/distribution facilities may need to be built and/or operated, transportation entities may need to be involved to get the products to consumers, etc., where each such facility and/or entity can produce a different degree of an environmental footprint or impact.

Upon consumers obtaining the products, they can begin using them, thereby producing exhaust, waste, and/or energy 222, which can also impact the environment, either directly or indirectly. For example, consumers purchasing gasoline to fuel their vehicles produce carbon dioxide exhaust by driving their vehicles. Production of the fuel includes its own additional environmental impacts as well. Different vehicles, different styles of driving, etc. can produce different degrees of carbon dioxide, thereby producing different impacts on the environment. It should be noted that consumer usage of the products can generate financial gain, which can be invested or otherwise used to produce more secondary products 206 and eventually consumer products 208, thereby increasing impact on the environment.

As the life-cycle of a product comes to an end (e.g., the product is no longer being used, becomes broken or otherwise cannot or is not being used, etc.), consumers can discard such products either as waste, recyclable materials, and/or as other disposable materials 210. Such disposal can also produce its own impact on the environment as well as other forms of energy 224. Energy 224 can be used to aid in the initial production 202.

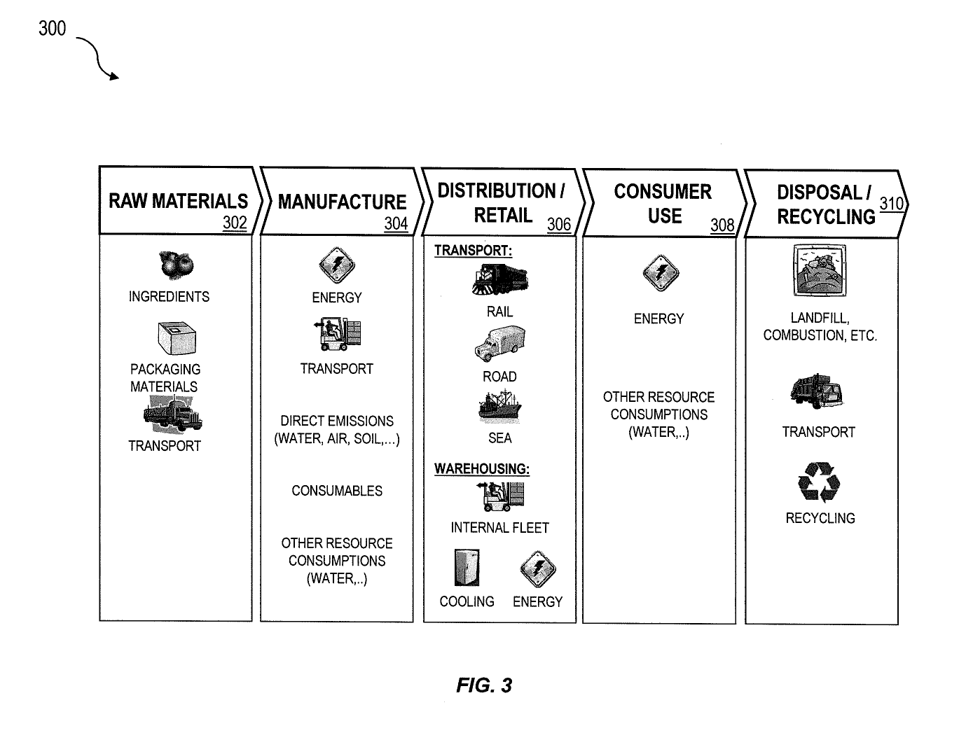

Each stage 202, 204, 206, 208, and 210 discussed above can produce its own form of an environmental impact that can contribute to the total footprint or impact 220 on the environment. FIG. 3 illustrates some exemplary input and output variables and results, including but not limited to, parameters, materials, entities, energy, resources, methodologies, actions, etc., that can be involved at each stage. During a “raw materials” stage 302, the variables can include ingredients, packaging materials, transportation, equipment that may be needed to obtain such ingredients, materials, etc., as well as human variables (e.g., labor, skills, technology, etc.). Once the “raw materials” stage 302 is completed, the life-cycle can proceed to “manufacture” stage 304 of the life-cycle 300. During this stage, the variables can include energy, transportation, emissions (e.g., carbon dioxide, water, air, soil, etc.), consumable goods, as well as other resource consumptions (e.g., water, air, oil, gas, natural resources, etc.). During the “distribution/retail” stage 306, the variables can include transportation variables and storage/warehousing variables. Some exemplary forms of transportation variables can include railroads, marine transportation, air transportation, ground transportation, etc. The storage/warehousing variables can include energy consumption (e.g., electricity, cooling, heating, etc.), internal warehousing units for loading, unloading, moving around, etc. of products that can be used by consumers in the future. In the “consumer use” stage 308, energy and other resources (e.g., oil, gas, water, air, etc.) can be used for use by the consumer. The life-cycle of a product can come to an end during the disposal/recycling stage 310, where variables include usage of landfill/combustion facilities, transportation of disposed products, recycling, etc., each of which can affect the environment in various ways. each stage can also include various financial, legal, regulatory, environmental, and human variables that can be associated with the advancing of the life-cycle of a product from “birth” to its “grave.”

Accounting for the individual and/or total impacts and/or sources of such impacts as well as each variable during the life-cycle of the product can be important in order to improve manufacturing, distribution, disposal, etc. of the products as well as to minimize an environmental impact produced by the life-cycle of a product. Such accounting can be used for various financial, legal, regulatory, etc. purposes, such as creation of a system for purchasing and/or trading of “green” debits/credits, abatements, etc. that can be associated with various stages of the life-cycle of a product.

Various implementations of the current subject matter can be used to determine an environmental impact of a product, service, etc. from “birth” of the product, service, etc. (e.g., commencement of the service or what may be needed to commence a service) to termination of the product, service, etc. Implementations of the current subject matter can also be used to determine impact of various products, services, actions, and/or activities in various mediums, e.g., environmental, legal, financial, regulatory, social, political, and/or any other mediums, as well as a combination of various mediums (i.e., a cross-medium impact). For ease of illustration and following discussion, the following description will be provided in terms of an environmental impact of a life-cycle of a product from its “birth” (i.e., a raw materials stage) to its “grave” (i.e., disposal/recycling stage). Possible determinations of impacts that are consistent with implementations of the current subject matter include a total or aggregate impact of the life-cycle of the product; an impact of each individual stage in the life-cycle of the product; an impact of each activity within each individual stage in the life-cycle of the product is; costs associated with each activity within a stage, each stage, and/or total cost of the life-cycle of the product; origins of the each individual impacts in the life-cycle of the product; factors involved in creating an impact of the life-cycle of the product along with each activity and stage of the life-cycle of the product; and the like. Other determinations can be made as well.

In some implementations, a process for assessing impacts can generate a plurality of values that illustrate the impacts of activities and stages of the life-cycle of the product, which can be used to determine the total impact of the life-cycle of the product. Such a process can be used by various entities that are involved manufacture, distribution, retail, disposal of the product and/or involved in providing materials that can be used to manufacture, distribute, retail, dispose the product to design a better product that can have a smaller impact, compare actual impact (that can be produced by each activity, stage, etc.) generated by the life-cycle of the product to a calculated impact generated during the design of the product (i.e., comparison of the design time impact (hypothetical) versus result time impact (actual)). Such comparison can be used for various purposes, including reporting, compliance, accountability, and others. For example, an entity running its conveyor belts that use electricity, produced by solar power (as opposed to coal), can show that its generated product is cleaner (i.e., less CO₂ emissions) and hence may be entitled to various “green” debits/credits, abatements, etc. to offset the total impact of its product on the environment in view of its other less environmentally-clean activities (e.g., use of gasoline-based transportation to deliver its product).

An impact of each stage in the life-cycle of a product can be determined based on the types of activities that are performed during such stage, separate actions/calculations that can be used to determine values classifying each activity, various external factors (e.g., governmental, financial, environmental, social, etc. laws, rules, regulations, standards, recommendations, etc.), the total impact of each stage, etc. Activities can correspond to variables (whether constant or floating) indicating various impact by each activity that can be involved in each particular stage. Each stage can have a plurality of variables, where each activity in each stage can be identified by one or more variables. Upon determining the variables involved in each stage, one or more variables can be used in a calculation or a formula to determine values representing each particular activity. In some implementations, such formulas can be predetermined for each particular activity or can be generic based on the type of environmental impact (e.g., a formula to determine production of CO₂ by a vehicle having a particular engine, weight, etc. and using a particular brand and type of gasoline/diesel).

The formulas can also take into consideration various other factors, e.g., such as types of materials, products, source(s) of materials/products involved, specific processes involved, etc., to compute the values for each activity in the stage. Also, application of external factors that might not be related to actual materials, products and/or processes involved in a particular activity at each stage can be used to determine a total value for each activity involved in each stage. Such external factors can include but are not limited to factors resulting from various governmental, financial, legal, social, political, industrial, etc. rules, regulations, laws, standards, etc. (e.g., use of nuclear energy for supplying electricity to run plants that convert raw materials into secondary products can generate a factor that reduces the total value that can be generated by the same plants that use coal-produced electricity). It should be noted that the formulas that can be used to calculate values for each activity can also use values that can be computed for other activities during the same stage and/or other stages. During each stage, the totals for each activity can be computed based on the values and various external factors. Also, a total value for all activities can be computed based on the totals for each activity performed during the same stage as well as values corresponding to activities performed during other stages. To determine an impact of the life-cycle of a product, a total of all stages can be computed based on stage totals (along with other values) and various external factors discussed above. Further, the totals for each stage and an overall total can be computed by selectively using values corresponding to activities performed during the same stage and/or other stages. For example, some activities may include certain impact mitigations or exemptions or should otherwise be assigned a lower than expected or otherwise alternative impact, for example due to governmental regulation, the use of “green” or “clean” energy sources (e.g. wind, solar energy, etc.), or the like. While use of green energy sources may prevent a direct environmental impact, materials used to make components of such energy generation equipment can be produced as a result of “unclean” activities. Such activities can be included in calculations of the total impact of a life-cycle of a product but accounted for separately to allow tracking of the use of “green” or other alternative energy sources, material sources, or the like having reduced or otherwise atypical impacts.

The totals and, hence an impact of a product's life-cycle, can be calculated prior to completion of the life-cycle of the product and/or even before its “birth.” This calculation can be based on prior calculations, existing data, laws, rules, regulations, standards, recommendations, etc. Such calculation can be used to determine various costs associated with the life-cycle of the product, including production, usage, transportation, storage, disposal, etc. costs and to generate recommendations for reducing the costs that may be associated with an impact of the life-cycle of the product. For example, determination that usage of nuclear energy to run conveyor belts to make a particular product as opposed to coal can reduce eventual environmental “costs” or pollution credits that the entity making the product (and eventually other entities involved during the life-cycle of a product) will have to contribute or pay to make the product “greener” or more environmentally friendly.

In some implementations, determination of the total impact of the life-cycle of a produce can be performed iteratively by using determined values (whether existing or newly-determined) that can correspond to newly implemented, existing, and/or contemplated activities for each stage of the life-cycle of the product. The determined total impact values can be used to compare to the values produced by life-cycles of other similarly situated products (e.g., yogurts that are produced from materials coming from different geographical locations). These values can be used to determine impacts of life-cycles of products that have not yet been produced, sold, disposed of, etc. and compare them to actual products (e.g., costs of making, costs of distributing, costs of disposal, etc.).

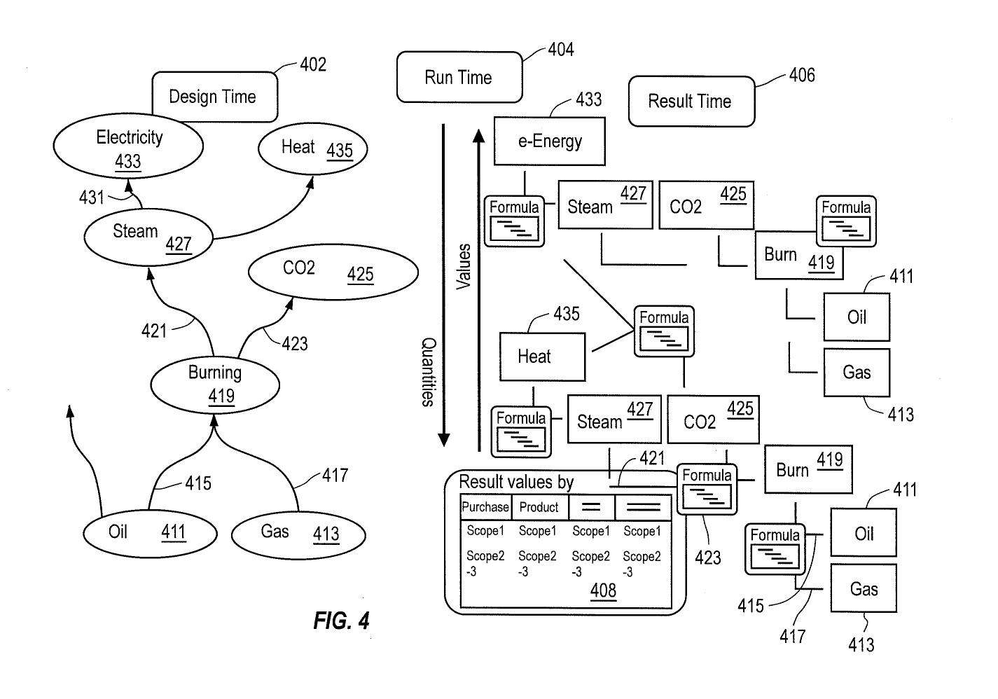

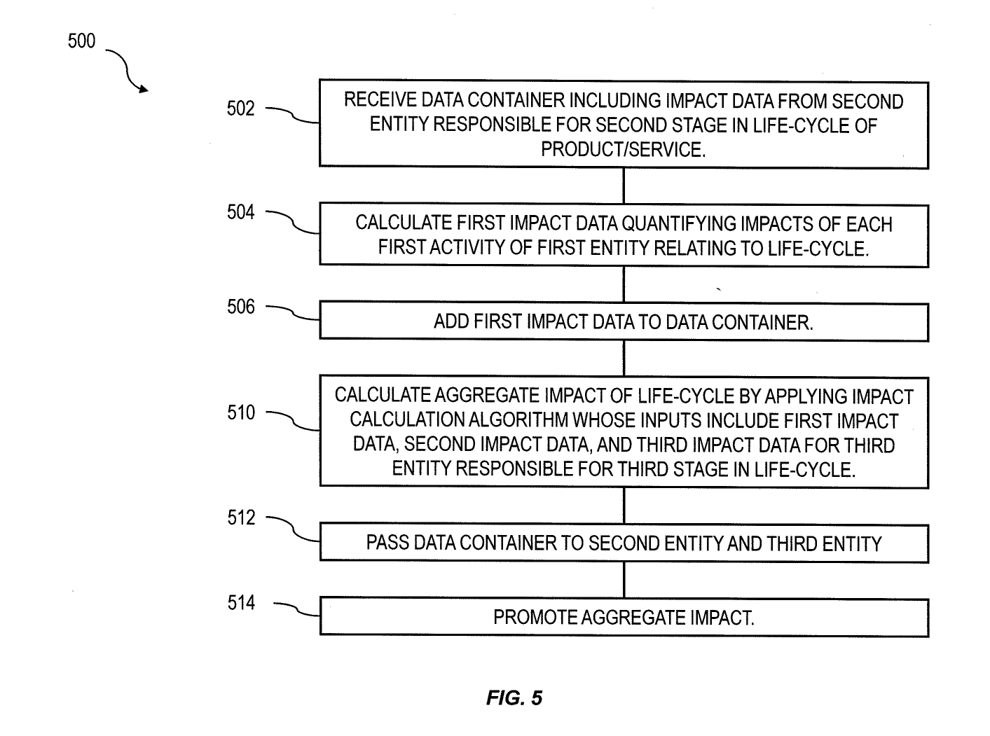

Implementations of the current subject matter can be configured to retain and transmit impacts or footprints of each particular activity within each phase of the life-cycle of the product. This information along with the determined total values can be sorted by types of activities, materials, products, resources used, locations, costs, etc. and stored as an autonomous data container that can be passed along the life-cycle chain of a product to enable characterization of the total footprint at any point along the chain. FIG. 4 shows an illustrative example of an impact diagram 400 illustrating calculation of an impact of a life-cycle of a product as it relates to production of carbon dioxide. The system 400 can include a design time aspect 402, a run time aspect 404, and a result time aspect 406. The determinations of the carbon dioxide emissions can be indicated in table 408. During design time, each component, material and/or action can be indicated by nodes: materials: nodes 411 (“oil”), 413 (“gas”); actions: nodes 419 (“burning”), 431 (“steam”); products/byproducts: nodes 425 (CO₂), 433 (“electricity”), 435 (“heat”). The connectors or “edges” between the nodes can represent various actions that can be applied to the values contained within the nodes. The nodes and edges in FIG. 4 can correspond to the values and formulas discussed above in connection FIGS. 5a-e.

As shown in FIG. 4, each node and edge shown in the design time aspect 402 can have a corresponding node and edge in the run time aspect 406. Further, as the calculation of the impact of the CO₂ progresses, the number of values generated can increase, while the amount of input variables can decrease, i.e., the calculation can proceed closer to the result.

In particular, information located in the nodes 411 and 413 can be used as input for node 419 via calculations on nodes or edges 415 and 417. Similarly, the information from the node 419 can be used as input to determine information in the nodes 427 and 425 using edges 421 and 423, respectively (i.e., burning (node 419) of oil and/or gas (nodes 411, 413, respectively) produces (edges 421, 423) steam (node 427) and carbon dioxide (node 425)). Further, information in node 427 can be used to determine information in nodes 433 and 435 via respective edges 431 and 429, respectively (i.e., steam (node 427) generates (edges 431, 429) electricity (node 433) and/or heat (node 435). The result of the calculation is production of electricity and/or heat and a byproduct—a carbon dioxide emission as a result of burning of oil and/or gas. The determined values can be allocated to table 408 for reporting, review, analysis, abatements, credits/debits, costs, and other determinations.

FIG. 5 shows a flow chart 500 illustrating a method consistent with features of one or more implementations of the current subject matter. At 502, a first entity responsible for a first stage in a life-cycle of one or more of a product and a service can receive a data container from a second entity responsible for a second stage in the life-cycle. The second stage can precede the first stage in the life-cycle. The data container can include second impact data quantifying impacts of each second activity of the second entity relating to the life-cycle and third impact data quantifying impacts of each third activity of a third entity relating to the life-cycle. The third entity can be responsible for a third stage in the life-cycle that either precedes or follows the first stage. At 504, first impact data can be calculated to quantify impacts of each of at least one first activity of the first entity relating to the life-cycle. The first impact data can be added to the data container at 506. At 510, an aggregate impact of the life-cycle can be calculated by applying an impact calculation algorithm whose inputs comprise the first impact data, the second impact data, and the third impact data. The data container can be passed to the second entity and the third entity at 512, and the aggregate impact can be promoted at 514.

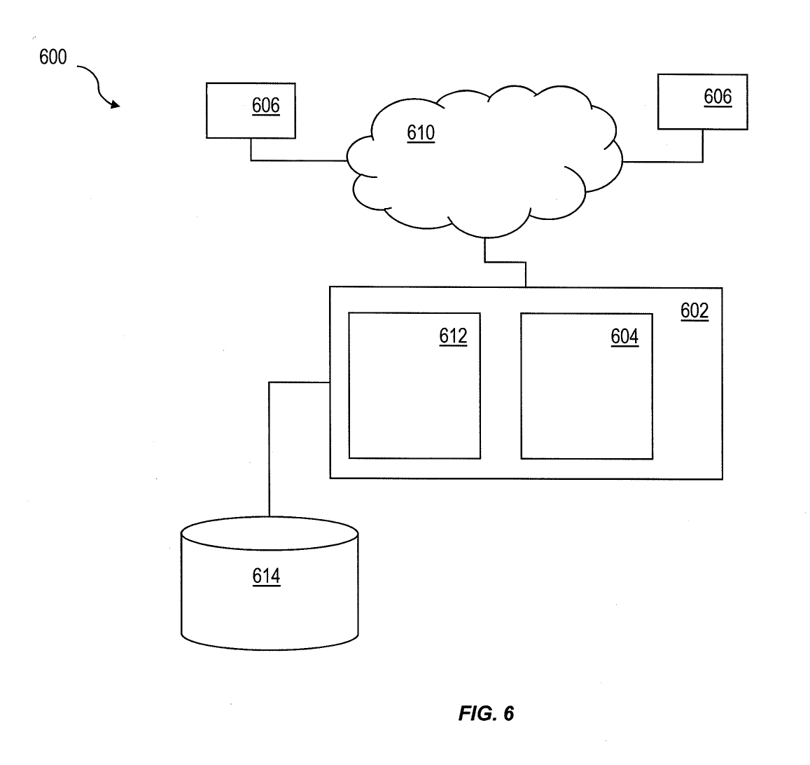

FIG. 6 shows a diagram illustrating a system 600 consistent with features of one or more implementations of the current subject matter. A computing system 602 that can include one or more programmable processors, which can be collocated, linked over one or more networks, etc., can execute one or more first modules 604 that provide one or more business software application functions related to activities of a first entity that pertain to production of a product or service. The one or more first modules 604 can be accessible to local users as well as remote users accessing the computing system 602 from one or more client machines 606 over a network connection 610. One or more user interface screens produced by the one or more first modules can be displayed to a user, either via a local display or via a display associated with one of the client machines 606. A life-cycle impact module 612 can receive and retain, for example in a database 614, data pertaining to impacts of other activities other entities involved in production of the product or service. The data can be received in the form of an autonomous data container to which each other entity conducting activities earlier in the life-cycle than the first entity has added data pertaining to that other entities impact contribution. The life-cycle impact module 612 can add data pertaining to the first entity's contributed impact, calculate a total impact, perform other functions as described herein, and the like.

In some implementations, one or more of the following features can also be included. The impact can include at least one of the following: an environmental impact, a financial impact, a legal impact, a political impact, a regulatory impact, a business impact, and a social impact. The determining of the impact can include receiving information concerning at least one external factor associated with the life-cycle of the product and applying the at least one external factor to the determination of the impact of each stage of the life-cycle of the product or the service and the total impact of the life-cycle of the product or the service. At least one external factor can include at least one of the following: financial, governmental, industrial, political, business, and social rules, regulations, laws, standards, and recommendations. Stages of the life-cycle of the product or the service can include at least one of the following: raw materials stage, manufacturing stage, distribution stage, consumer use stage, and disposal stage. Each stage in the life-cycle of the product or the service can include at least one activity performed during the life-cycle of the product or the service. A determination of an impact of each activity performed during the life-cycle of the product or the service can be made. A report illustrating an impact of each activity, an impact of each stage in the life-cycle of the product or the service and the total impact of the life-cycle of the product or the service can be generated. The report can include cost information associated with each activity, each stage of the life-cycle of the product or the service and the total impact of the life-cycle of the product or the service. Sorting of each activity according to at least one category can be performed.

Aspects of the subject matter described herein can be embodied in systems, apparatus, methods, and/or articles depending on the desired configuration. In particular, various implementations of the subject matter described herein can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. A client and server are generally, but not exclusively, remote from each other and typically interact through a communication network, although the components of the system can be interconnected by any form or medium of digital data communication. Examples of communication networks include, but are not limited to, a local area network (“LAN”), a wide area network (“WAN”), and the Internet. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

What is claimed:

1. A computer program product comprising a machine-readable medium storing instructions that, when executed by at least one programmable processor, cause the at least one programmable processor to perform operations comprising:
receiving, at a first entity responsible for a first stage in a life-cycle of at least one of a product, a service, an entity, a process, and a business unit, a data container from a second entity responsible for a second stage in the life-cycle, the second stage preceding the first stage in the life-cycle, the data container comprising second impact data quantifying impacts of each second activity of the second entity relating to the life-cycle and third impact data quantifying impacts of each third activity of a third entity relating to the life-cycle, the third entity being responsible for a third stage in the life-cycle that either precedes or follows the first stage;
calculating first impact data quantifying impacts of each first activity of the first entity relating to the life-cycle;
adding the first impact data to the data container;
calculating an aggregate impact of all or part of the life-cycle by applying an impact calculation algorithm whose inputs comprise the first impact data, the second impact data, and the third impact data;
passing the data container to the second entity and the third entity; and
promoting the aggregate impact.

2. A computer program product as in claim 1, wherein the aggregate impact includes at least one of an environmental impact, a financial impact, a legal impact, a political impact, a regulatory impact, a business impact, and a social impact.

3. A computer program product as in claim 1, wherein the first impact data, the second impact data, and the third impact data each comprise information concerning at least one external factor associated with the life-cycle of the product.

4. A computer program product as in claim 1, wherein the container comprises the impact data values as at least one of totals and vectors.

5. A computer program product as in claim 1, wherein the promoting comprises:
generating a report comprising at least one of quantified impacts associated with each of the first activity, second activity, and third activity; total impacts associated with each of the first entity, the second entity, and the third entity; the aggregated impact; and cost information associated with each quantified impact; and
at least one of storing the report on a computer storage device, displaying the report to a user via a computer display device, and electronically transmitting the report to one or more users.

6. A computer program product as in claim 1, wherein the calculating of the aggregate impact further comprises: representing each of the first entity, the second entity, and the third entity nodes or edges in a net-like computation structure; and wherein
the impact calculation algorithm comprises an operator that performs computations on at least one of the nodes and the edges in the net-like structure, the at least one operator being editable independently of a definition of the net-like computation structure.

7. A computer program product as in claim 1, wherein the operations further comprise dynamically deriving a new container at runtime to provide a newly specified calculation whose definition is received via input from a user.

8. A system comprising:
at least one programmable processor; and
a machine-readable medium storing instructions that, when executed by the at least one programmable processor, cause the at least one programmable processor to perform operations comprising:
receiving, at a first entity responsible for a first stage in a life-cycle of at least one of a product, a service, an entity, a process, and a business unit, a data container from a second entity responsible for a second stage in the life-cycle, the second stage preceding the first stage in the life-cycle, the data container comprising second impact data quantifying impacts of each second activity of the second entity relating to the life-cycle and third impact data quantifying impacts of each third activity of a third entity relating to the life-cycle, the third entity being responsible for a third stage in the life-cycle that either precedes or follows the first stage;
calculating first impact data quantifying impacts of each first activity of the first entity relating to the life-cycle;
adding the first impact data to the data container;
calculating an aggregate impact of all or part of the life-cycle by applying an impact calculation algorithm whose inputs comprise the first impact data, the second impact data, and the third impact data;
passing the data container to the second entity and the third entity; and
promoting the aggregate impact.

9. A system as in claim 8, wherein the aggregate impact includes at least one of an environmental impact, a financial impact, a legal impact, a political impact, a regulatory impact, a business impact, and a social impact.

10. A system as in claim 8, wherein the first impact data, the second impact data, and the third impact data each comprise information concerning at least one external factor associated with the life-cycle of the product.

11. A system as in claim 8, wherein the container comprises the impact data values as at least one of totals and vectors.

12. A system as in claim 8, wherein the promoting comprises:
generating a report comprising at least one of quantified impacts associated with each of the first activity, second activity, and third activity; total impacts associated with each of the first entity, the second entity, and the third entity; the aggregated impact; and cost information associated with each quantified impact; and
at least one of storing the report on a computer storage device, displaying the report to a user via a computer display device, and electronically transmitting the report to one or more users.

13. A system as in claim 8, wherein the calculating of the aggregate impact further comprises: representing each of the first entity, the second entity, and the third entity nodes or edges in a net-like computation structure; and wherein
the impact calculation algorithm comprises an operator that performs computations on at least one of the nodes and the edges in the net-like structure, the at least one operator being editable independently of a definition of the net-like computation structure.

14. A system as in claim 8, wherein the operations further comprise dynamically deriving a new container at runtime to provide a newly specified calculation whose definition is received via input from a user.

15. A computer-implemented method comprising:
receiving, at a first entity responsible for a first stage in a life-cycle of at least one of a product, a service, an entity, a process, and a business unit, a data container from a second entity responsible for a second stage in the life-cycle, the second stage preceding the first stage in the life-cycle, the data container comprising second impact data quantifying impacts of each second activity of the second entity relating to the life-cycle and third impact data quantifying impacts of each third activity of a third entity relating to the life-cycle, the third entity being responsible for a third stage in the life-cycle that either precedes or follows the first stage;
calculating first impact data quantifying impacts of each first activity of the first entity relating to the life-cycle;
adding the first impact data to the data container;
calculating an aggregate impact of all or part of the life-cycle by applying an impact calculation algorithm whose inputs comprise the first impact data, the second impact data, and the third impact data;
passing the data container to the second entity and the third entity; and
promoting the aggregate impact.

16. A method as in claim 15, wherein the aggregate impact includes at least one of an environmental impact, a financial impact, a legal impact, a political impact, a regulatory impact, a business impact, and a social impact.

17. A method as in claim 15, wherein the container comprises the impact data values as at least one of totals and vectors.

18. A method as in claim 15, wherein the promoting comprises:
generating a report comprising at least one of quantified impacts associated with each of the first activity, second activity, and third activity; total impacts associated with each of the first entity, the second entity, and the third entity; the aggregated impact; and cost information associated with each quantified impact; and
at least one of storing the report on a computer storage device, displaying the report to a user via a computer display device, and electronically transmitting the report to one or more users.

19. A method as in claim 15, wherein the calculating of the aggregate impact further comprises: representing each of the first entity, the second entity, and the third entity nodes or edges in a net-like computation structure; and wherein
the impact calculation algorithm comprises an operator that performs computations on at least one of the nodes and the edges in the net-like structure, the at least one operator being editable independently of a definition of the net-like computation structure.

20. A method as in claim 15, wherein at least one of the receiving, the calculating of the first impact data, the adding, the calculating of the aggregate impact, the passing, and the promoting are performed by at least one programmable processor.
